(19) United States
(12) Patent Application Publication
(10) Pub. No.: US 2014/0045162 A1
(43) Pub. Date: Feb. 13, 2014

(54) Device of Structuring Learning Contents, Learning-Content Selection Support System and Support Method Using the Device

(71) Applicant: Hitachi. Ltd., Tokyo (JP)

(72) Inventors: Haru ANDO, Kunitachi (JP); Ryuji MINE, Kokubunji (JP); Masakazu FUJIO, Fuchu (JP)

(21) Appl. No.: 13/926,077

(22) Filed: Jun. 25, 2013

(30) Foreign Application Priority Data
Aug. 9, 2012 (JP) 2012-176683

(51) Int. Cl. G09B 5/00

(52) U.S. Cl. CPC G09B 5/00
USPC 434/322

(57) ABSTRACT

A device of structuring learning contents includes a lesson state data acquisition unit acquiring data of a state of a lesson given by displaying the learning content using an electronic blackboard and a server connected to the electronic blackboard, the lesson state data acquisition unit and a database through a network, in which the server has a lesson state data analysis unit extracting a feature amount of the lesson from the lesson state data, a type classification unit analyzing the feature amount of the lesson and classifying the lesson as a lesson type and an attitude type, a content evaluation unit evaluating the learning content from the feature amount of the lesson, and a content-tag data generation unit giving a content tag including content tag data based on the analysis/evaluation result to the learning content to structure the learning contents.

### BACKGROUND OF THE INVENTION

1. Field of the Invention

The present invention relates to a device of structuring learning contents suitable for supporting selection of the learning content when a teacher and the like make an education plan, a learning-content selection support system and a support method using the device.

2. Background Art

In recent years, the development of a digital textbook is proceeding on the assumption that electronic devices such as a large-sized display, a tablet terminal and a digital pen are used for lessons at elementary and junior high schools. The digital textbook is utilized for lessons in a manner in which not only a teacher but also each pupil (student) holds each information terminal respectively, and these information terminals are mutually connected to an electronic blackboard through a network. It is expected that pupils maintain their interest by using the digital textbook.

On the other hand, a lesson support system which facilitates the use of the digital textbook by teachers and the like is also being developed.

A lesson support system is disclosed in JP-A-2011-48042 (Patent Document 1), in which a lesson support server is controlled by clicking, with a digital pen, an icon for controlling the lesson support server printed on a dedicated form for the digital pen. In JP-A-2011-154443 (Patent Document 2), there is disclosed an information processing system in which text preparation is supported by integrally performing management and mutual utilization of written data inputted by a digital pen and data inputted by a PC.

Additionally, in JP-A-2012-14267 (Patent Document 3), there is disclosed an information analysis device capable of easily capturing how Internet is used in members of an organization based on search keywords used in the organization. In Patent Document 3, there is also disclosed a technology in which an operation log of each user terminal device is generated in a Web server and managed in a log management server to analyze a browsing history of Web sites by the information analysis device.

### SUMMARY OF THE INVENTION

The move of introducing the digital textbook is being globalized, and infrastructure improvement such as maintenance/operation of networks and devices is proceeding. In order to spread the lesson using such digital textbook, it is necessary to enhancing quality of intangibles for supporting teachers such as effective teaching materials and teaching methods.

For example, when a teacher makes a plan for the lesson using the digital textbook such as the electronic blackboard, he/she can refer to information of past experience about a learning content desired to be used if such information exists. Even when the same learning content is used, learning effects may be different according to the difference of environment in a place of education which is, for example, members of a class. Accordingly, it is desirable that the learning content whereby high learning effects can be expected is easily extracted with respect to a specific plan for the lesson of the teacher himself/herself with a small burden.

However, there is no disclosure relating to the above demands or solutions thereof in Patent Documents 1, 2 and 3.

It is desirable to provide a device of structuring learning contents, a learning-content selection support system and a support method using the device capable of easily selecting the learning content suitable for a lesson plan of a teacher himself/herself and whereby high leaning effects can be expected.

A typical embodiment of the present invention is as follows. A device of structuring learning contents includes an electronic blackboard displaying a learning content, a lesson state data acquisition unit acquiring data of a state of a lesson given by displaying the learning content using the electronic blackboard and a server connected to the electronic blackboard, the lesson state data acquisition unit and a database through a network, in which the server has a lesson state data analysis unit extracting a feature amount of the lesson from the lesson state data, a type classification unit analyzing the feature amount of the lesson and classifying the lesson as a lesson type and an attitude type, a content evaluation unit evaluating the learning content from the feature amount of the lesson, and a content-tag data generation unit giving a content tag including content tag data based on the analysis/evaluation result to the learning content to structure the learning contents.

According to the embodiment of the present invention, the device of structuring learning contents supporting the selection of the learning contents based on data of actual use states of learning contents can be provided. Additionally, a system and a method supporting the selection of learning contents whereby high leaning effects can be expected by applying the device.

### BRIEF DESCRIPTION OF THE DRAWINGS

FIG. 1 is a block diagram showing a configuration of a system structuring learning contents on the assumption that the system is used in a lesson given by a teacher at school according to a first embodiment of the present invention;

FIG. 2 is a diagram showing an example of a program/data structure stored in a database in the first embodiment;

FIG. 3 is a chart showing a structure example of lesson contents;

FIG. 4 is a flowchart showing an example of the flow of generating a content tag in the first embodiment;

FIG. 5 is a view showing an example of presentation of lesson contents during the lesson, states of the teacher and students, feature amount abstraction, type classification and evaluation corresponding to the presentation;

FIG. 6 is a chart showing an example of a data structure of input by teacher/students during presentation of the contents;

FIG. 7 is a view showing school/year/grade/class/student information;

FIG. 8 is a view showing an example of lesson content tag data;

FIG. 9 is a view showing an example of an evaluated lesson content information table;

FIG. 10 is a flowchart showing an example of the flow of selecting the evaluated lesson contents;

FIG. 11 is a view showing an example of a screen used when performing user registration by a teacher GUI;

FIG. 12 is a view showing an example of a screen used when performing student registration by the teacher GUI;

FIG. 13 is a view showing an example of a screen used when performing student registration by the teacher GUI;

FIG. 14 is a view showing an example of a condition setting screen by the teacher GUI; and

FIG. 15 is a view showing an example of a time setting screen by the teacher GUI.

### DESCRIPTION OF PREFERRED EMBODIMENTS

A device of structuring learning contents, a learning-content selection support system and a support method using the device according to an embodiment of the present invention can be applied to not only a lessen given by a teacher at school described below but also a case where a lecturer gives a lecture at a company and other occasions.

Hereinafter, embodiments of the present invention will be explained with reference to the drawings.

### Embodiment 1

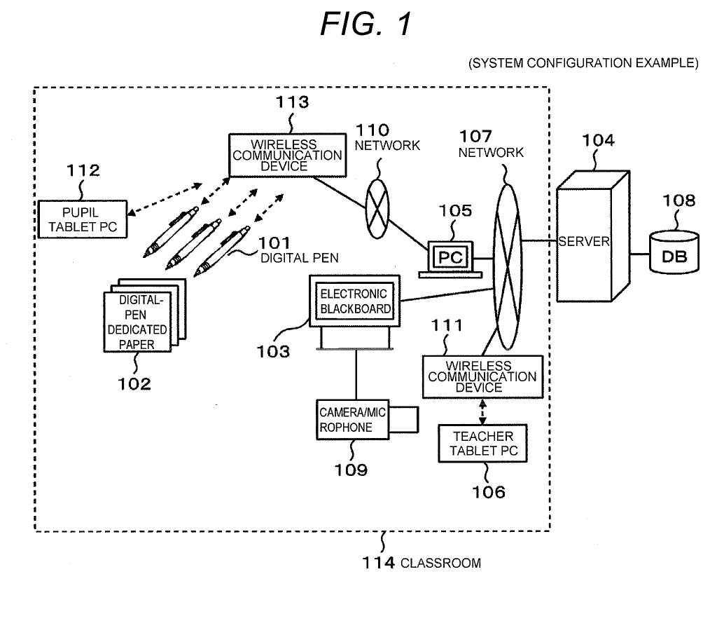

FIG. 1 is a block diagram showing a configuration of a system structuring learning contents and supporting selection of the learning contents by using the structure on the assumption that the system is used in a lesson given by a teacher at school according to a first embodiment of the present invention.

In the present system, a server 104 executing various functions for performing educational support by managing and delivering information and a database 108 storing various data/programs are connected through a network. The server 104 has a function of analyzing information of a lesson using a learning content and giving a content tag to the learning content based on the analysis result to structure the learning content, and a function of supporting selection by using the structured learning contents. In the database 108, at least information of a video, audio, an electronic blackboard and so on in the lesson is stored with a video content of the lesson. An electronic blackboard 103 acquiring the contents written by a teacher (instructor) during the lesson as electronic data, a client PC 105, a lesson video imaging camera/microphone 109 imaging behaviors of the teacher and pupils during the lesson in a classroom 114 are connected to the server 104 through a network 107 (for example, Internet).

The electronic blackboard 103 is an interactive blackboard having a direct instruction device (not shown) such as an electronic pen, having functions of switching the display of contents on a screen by performing an icon operation, a scroll operation, a mouse (not shown) operation and so on directly on the screen of the blackboard, expanding/contracting part of the content and storing/outputting the contents inputted by handwriting using the electronic pen and so on as electronic data. The client PC 105 has a function of presenting a lesson application to a teacher and proceeding with the lesson by using lesson contents selected by the lesson application. The client PC 105 is a normal computer as an information processing device, including a CPU as a processing unit, a memory or a storage device as a storage unit, a display unit and an input unit, which are connected by an internal bus. There is also a teacher tablet PC 106, which is connected to a first network 107 through a wireless communication device 111. The teacher tablet PC 106 functions as a GUI used when the teacher inputs/browses information with respect to the server 104, the client PC 105, the electronic blackboard 103 or the like. The tablet PC is a portable multifunctional terminal formed in a flat-plate shape having a touch-panel type display/input unit.

As devices for handwriting input for teachers and pupils (students), a digital-pen dedicated paper 102 on which a dot pattern for detecting a position of a writing material is printed and a digital pen 101 including a camera device and a communication function for acquiring an image of the dot pattern at the time of writing are used in this case. Concerning the details of structures and functions of the digital-pen dedicated paper and the digital pen, description of Patent Document 2 is quoted. The digital pen 101 and the digital-pen dedicated paper 102 are connected to the client PC 105 through a wireless communication device 113 and a second network 110. A pupil tablet PC 112 may be used with the digital pen and the digital dedicated paper. Or, the tablet PC 112 having functions of the digital pen and the digital-pen dedicated paper may be used instead of the digital pen and the digital-pen dedicated paper.

Information including an ID of the digital pen and time-series data of handwriting data is transmitted from the digital pen 101 to the server 104 through the client PC 105 in a given data format. The handwriting data includes positional information on the digital-pen dedicated paper 102 and output values of a pressure sensor. The handwriting information by the digital pen 101 is transmitted to the server 104 and the client PC 105 through the communication device 113 and the network. The server 104 or the client PC 105 stores the transmitted data as writing data in a memory or a hard disk as a storage unit thereof. The server 104 or the client PC 105 calculates a correlation value quantitatively indicating content similarity between a character recognition result of the writing data and input data previously inputted every time writing data is inputted. When the obtained correlation value is, for example, 70%, the writing data is displayed on a display screen of the client PC and the like for outputting the data. The writing data is also transmitted from the server 104 to the teacher tablet PC 106 and the electronic blackboard 103. Concerning the details of processing of writing data, the description of Patent Document 2 is quoted.

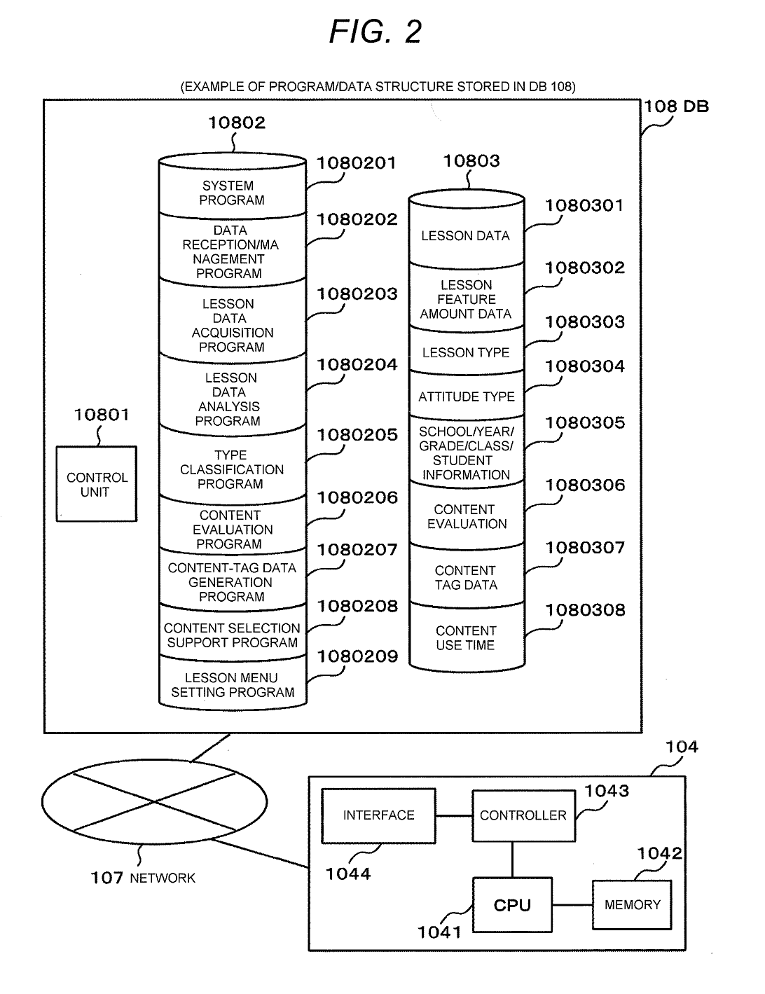

Next, structure examples of the server 104 and the database 108 will be explained with reference to FIG. 2. FIG. 2 is a diagram showing an example of a program/data structure stored in the database in the first embodiment.

The server 104 includes a CPU 1041 executing calculation processing, a memory 1042 temporarily storing program data, a controller 1043 performing control with respect to various interfaces and an interface 1044. The interface 1044 includes a network interface connecting to the external network 107 and a peripheral device interface connecting peripheral devices such as a display and a keyboard.

The database 108 includes a control unit 10801, a memory 10802, a hard disk 10803. In the memory 10802 (or the hard disk 10803), a system program 1080201, a data reception/management program 1080202, a lesson data acquisition program 1080203, a lesson data analysis program 1080204, a type classification program 1080205, a content evaluation program 1080206, a content-tag data generation program 1080207, a content selection support program 1080208 and a lesson menu setting program 1080209 as well as various data necessary for executing these programs are stored. In the hard disk 10803, a lesson data 1080301 accumulated by the lesson data acquisition program 1080203, a lesson feature amount data 1080302, a lesson type data 1080303, an attitude type data 1080304, a school/year/grade/class (size of a classroom Xm², the number of pupils n and so on)/student information (grade points in each subject) data (class type data) 1080305 and so on are stored. In the hard disk 10803, a content evaluation data 1080306, a content tag data 1080307 and a content use time table 1080308 are also stored.

Next, processing of data accumulation in the server 104 will be explained. First, the server 104 is activated and the electronic blackboard 103 and the camera/microphone 109 connected to the server are activated. Moreover, respective data accumulation programs are activated. As the control unit (CPU) 1041 of the server 104 executes programs stored in the memory 1042, the control unit (CPU) 1041 and the control unit 10801 of the database 108 function as a transmission unit, an analysis unit, an evaluation unit and so on. At this point, imaging of a lesson video is started and voice/sound is recorded in synchronization with the imaging of video data. At this time, a start time and an end time of the imaging are stamped in lesson video data, and a start time and an end time of the voice recording are also stamped in voice/sound data. Concerning point sequence data written on the electronic blackboard, coordinates on the electronic blackboard 103 are acquired by using a digital pen attached to the electronic blackboard, and time points when the digital pen is passed are stamped as sub-data of coordinate value data. When a recording button and the electronic blackboard are turned off at a point when a lesson ends, data transmitted to the server 104 is stored in the database 108 of the server 104 as a voice/sound data set, an electronic blackboard writing data set and so on. The stored respective data sets are stored as data set files, and data accumulation processing ends.

The CPU 1041 performs processing in the server 104 in accordance with the activated programs. The memory 1042 includes a DRAM reading the activated programs, data and so on and temporarily storing them. Specifically, when the server 104 is activated, the memory 1042 reads, in addition to the system program 1080201 controlling the entire system, the data reception/management program 1080202, the lesson data acquisition program 1080203, the lesson data analysis program 1080204, the type classification program 1080205, the content evaluation program 1080206, the content-tag data generation program 1080207, the content selection support program 1080208, the lesson menu setting program 1080209 and so on from the hard disk 1080003. The data reception/management program 1080202 performs management of transmission/reception of various types of data/information among the server, the database and various terminals. The lesson data acquisition program 1080203 acquires video and sound transmitted from the camera/microphone 109 and blackboard data transmitted from the electronic blackboard 103 and transmits feature data of these data to the server 104 for accumulating the data in the hard disk 10803 as a lesson feature amount. The server accumulates the feature amount in the hard disk 10803 as a video data set and a sound data set. Time information is also added to the accumulated data set.

The hard disk 10803 stores programs, data and so on. Data held in the hard disk 10803 is read on the memory 10802 according to need and processed by the control unit 10801.

When programs of FIG. 2 are executed on the CPU 1041 by using respective devices of a delivery system of FIG. 1, respective programs allow the CPU to execute the following functions. The lesson data acquisition program 1080203 allows the CPU to function as a lesson state data acquisition unit, accumulating information from the electronic blackboard and the camera/microphone in the hard disk 10803 as the lesson data 1080301. The lesson data analysis program 1080204 allows the CPU to function as a lesson state data analysis unit, accumulating analysis results of lesson data in the hard disk 10803 as the lesson feature amount data 1080302. The type classification program 1080205 allows the CPU to function as a type classification unit analyzing the lesson feature amount and classifying data as a lesson type and an attitude type, accumulating analysis results in the lesson type data 1080303 and the attitude type data 1080304. The lesson type indicates a format (pattern) in which the lesson is performed by the teacher, and there are various lesson types according to subjects and lesson forms such as “reproduction of blackboard writing” in which the teacher gives a lesson by speaking alone by using the electronic blackboard, “teacher/pupil turn” in which the lesson proceeds with a response (turn) of a pupil with respect to a question by the teacher, “group discussion” in which pupils have a discussion voluntarily regarding a subject set by a teacher and “report forming”. The attitude type is a pattern indicating response/attitude of pupils during the lesson, and there are various attitude types such as an ideal desirable response state and response states far from the ideal state as responses of pupils with respect to the lesson pattern, which are for example, “concentration”, “divergence”, “attentive hearing”, “writing quietly” and so on. As an example, “concentration” indicates a state in which most pupils are interested in the lesson and positively participate in the lesson. When the lesson type is “reproduction of blackboard writing”, “concentration” indicates a response state in which all pupils performs writing on dedicated papers using digital pens by receiving the writing on the electronic blackboard by the teacher. When the lesson type is “teacher/pupil turn”, “concentration” indicates a state in which many pupils actively make response to each question made by the teacher. In contrast to the above, “divergence” indicates a state in which most pupils are not interested in the lesson and talk in whispers.

The content evaluation program 1080206 allows the CPU to function as a content evaluation unit, accumulating content evaluation results in the hard disc 10803 as the content evaluation data 1080306. The content-tag data generation program 1080207 allows the CPU to function as a content-tag data generation unit, generating content tag data obtained by combining results of type classification/evaluation regarding respective analyzed and evaluated contents with class type data as a set, and accumulating the data in the hard disk 10803 as the content tag data 1080307. The lesson menu setting program 1080209 allows the CPU to function as a lesson menu setting unit presenting a menu screen necessary when a user sets a lesson menu by a GUI, accumulating the set lesson menu in the hard disk 10803 as the content use time table 1080308. The content selection support program 1080208 allows the CPU to function as a content selection support unit generating information of plural learning contents to be candidates with respect to the lesson menu set in the menu screen based on the content tag data 1080307 and presenting the information to the user when the user selects the leaning contents for setting the lesson menu by the GUI.

When structuring the leaning contents, parameters and determination conditions (thresholds) necessary for analyzing various types of data and evaluating contents are set in the system in advance. For example, parameters necessary for performing determination processing of the lesson type and the attitude type based on a lesson feature amount by the type classification program 1080205, and determination conditions (thresholds) necessary for evaluating contents based on the relationship of the lesson type and the attitude type. The evaluation of contents is performed in ranks of multiple stages, for example, approximately four or five stages.

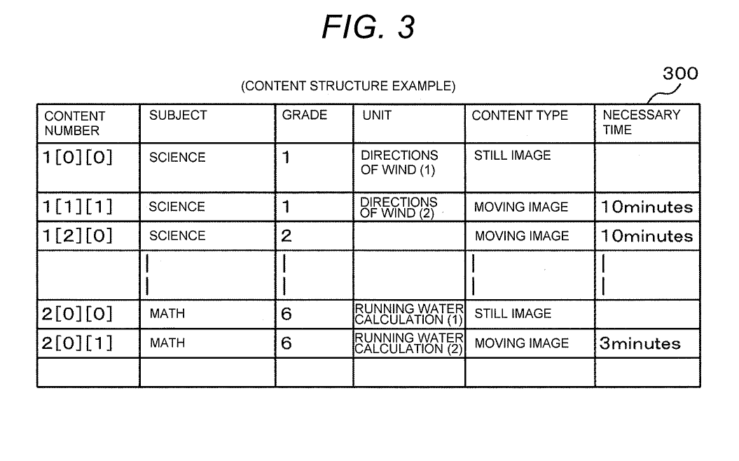

FIG. 3 shows a structure example of lesson (learning) contents.

Lesson contents 300 in the example include content numbers, subjects, grades, units, content types and necessary time as a structure of the contents. For example, the subject of a content number 1[0] [0] is science, a target is the first grade, the unit is “directions of wind (1)” and the content type is a still image. When the content type is a moving image, necessary time of reproduction thereof is recorded.

The lesson contents also include lesson texts such as computerized schoolbooks associated with video contents.

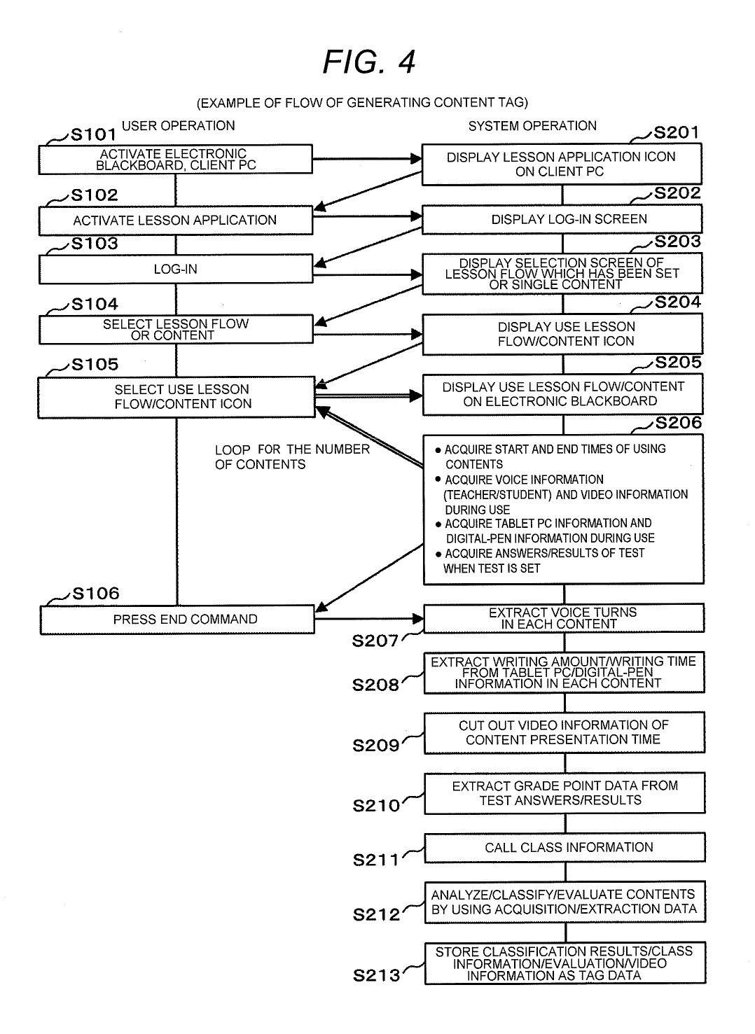

Next, an example of the flow of generating the content tag will be explained with reference to FIG. 4.

First, a user (teacher) activates the electronic blackboard 103 and the client PC 105 (S101). In response to this, the system (server 104) displays a lesson application icon on the client PC 105 (S201). When the user activates the lesson application (S102), a log-in screen is displayed on the client PC 105 (S202). When the user logs in (S103), a selection screen of a lesson flow which has been set by the user or a single content is displayed on the client PC 105 (S203). When the user selects the lesson flow which has been set by the user or the single content (S104), a use lesson flow/content icon is displayed on the client PC 105 (S204). When the user selects the use lesson flow/content icon (S105), the system (server 104) displays the use lesson flow/content on the electronic black board 103 (S205).

A state of the teacher and students shown when presenting the lesson content is acquired as lesson data and is accumulated in the server (S206). These processing is executed by the lesson data acquisition program 1080203. First, the system (server 104) acquires start and end times of using the content and accumulated the times in the system (server 104). Moreover, the system acquires voice information (teacher/student) and video information during use and store the information in the server. The system also acquires Tablet PC information and digital-pen information during use and accumulates the information in the server. Furthermore, when a test is set, the server acquires answers/results of the test and accumulates them in the server. These processing is repeated for the number of times corresponding to the number of contents used in the lesson.

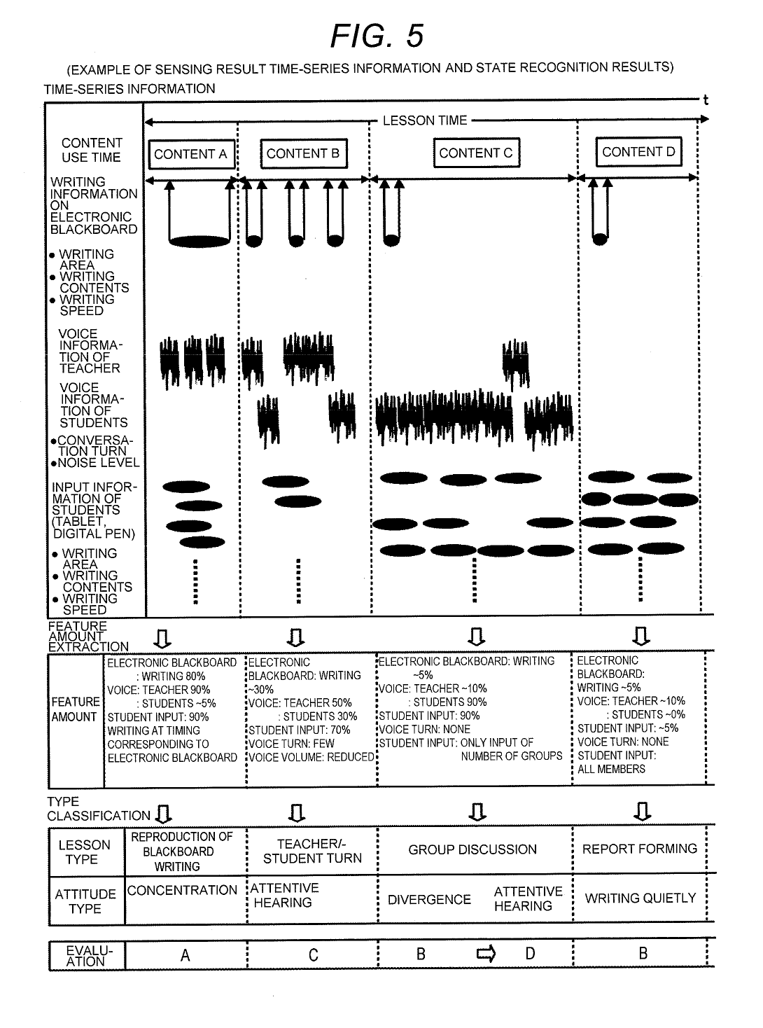

FIG. 5 is a view showing an example of presentation of lesson contents during the lesson, states of the teacher and students, feature amount abstraction, type classification and evaluation corresponding to the presentation.

In an upper column of FIG. 5, time-series information of presentation of the lesson contents during the lesson in the classroom and states of the teacher and the students corresponding to the presentation are shown. In this example, the lesson is given while using the lesson contents A, B, C and D sequentially. In a lesson using the lesson content A, writing information on the electronic blackboard, namely, a writing period on the electronic blackboard by the teacher is long, and a period during which voice information as explanation by the teacher is also long. Whereas, it is found that respective pupils spend long time for input to digital-pen dedicated papers by digital pens (or input by the tablet PC). There is no voice information and a conversation turn/noise level of students. In FIG. 5, display of specific contents of a writing area, writing contents and writing speed to the digital-pen dedicated papers is omitted. In a next lesson using the lesson content B, writing information on the electronic blackboard is discrete, and a period during which voice information of the teacher flows is also discrete. There is voice information of students in a form of following voice information of the teacher, however, there are few conversation turns. The input to the digital-pen dedicated papers by the digital pens (or the input by the tablet PC) is made after voice information of the teacher and students, part of students does not perform input by the tablet PC. Next, in a lesson using a lesson content C, there is writing information on the electronic blackboard at the beginning, then, active voice information of students follows in response to the writing and the input to the digital-pen dedicated papers by the digital pens is also performed. However, there is not a conversation turn and the noise level exists. Additionally, part of students does not perform input by the tablet PC at all. Furthermore, in a lesson using a lesson content D, there is writing information on the electronic blackboard at the beginning, then, all students perform input by the digital-pen dedicated papers by the digital pens in response to the writing. On the other hand, there is no voice information, no conversation turn and no noise level both in the teacher and students.

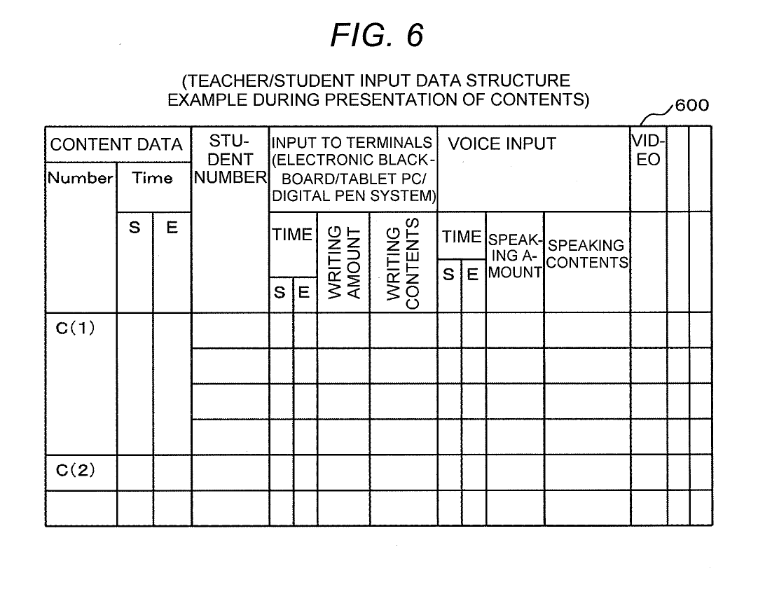

Various types of input data during the lesson and the like are accumulated in the server as a data structure 600 shown in FIG. 6. That is, information of lesson content data, student numbers, input to terminals (electronic blackboard/Tablet PC/digital system), voice input, video and so on is recorded in units of numbers (scene numbers) of content data. The data structure includes use time (start time and end time) of respective content data, input time (start time and end time) to terminals by the teacher or respective students, speaking time (start time and end time) and the speaking contents of the teacher and respective students and video data of the camera of the teacher and respective students.

Returning to FIG. 4, when the lesson ends and the user (teacher) presses an end command (S106), the system (server 104) extracts voice turns in each content (S207) in response to the command, extracts writing amount/writing time from Tablet PC/digital pen information in each content (S208), cuts out video information of content presentation time (S209) and performs extraction of grade point data from test answers/results (S210). Furthermore, class type information is called (S211).

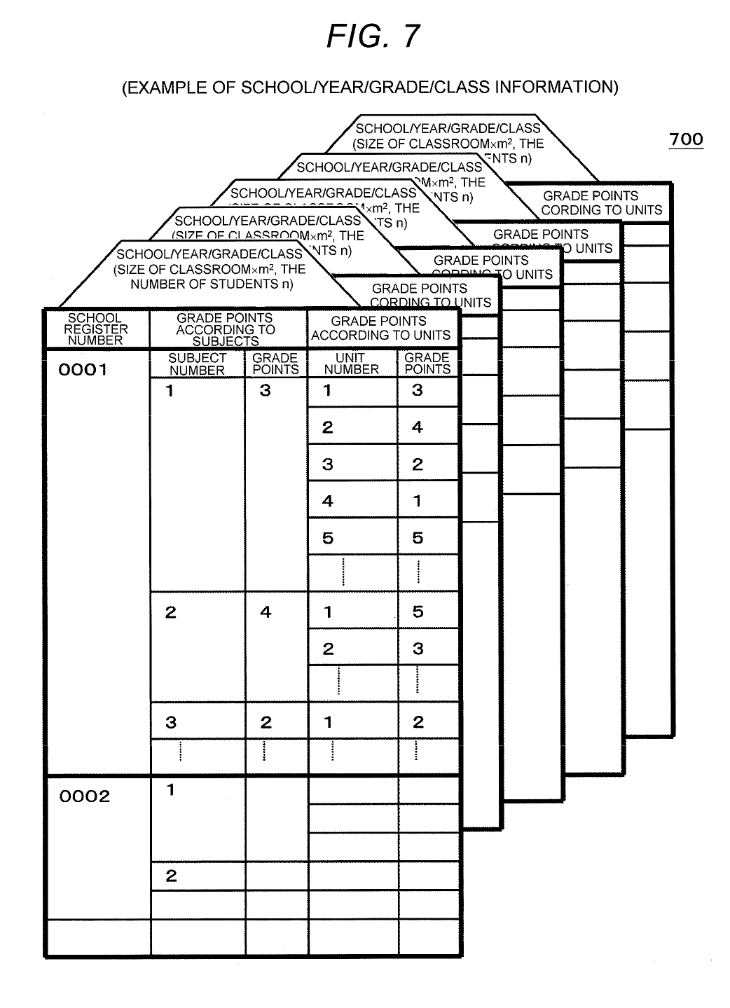

FIG. 7 shows an example of class type information 700 stored as the school/year/grade/class/student information 1080305. The class type information 700 has school/year/grade/class/information, including data of the size of a classroom where the lesson has been given Xm², the number of students “n”, school register numbers of respective students, grade points of respective students according to subject and so on which are generated according to units as class type information, in addition to general information of school/year/grade and so on.

Next, the system (server 104) performs analysis/classification of contents by using acquisition/extraction data by the lesson data analysis program 1080204 and the type classification program 1080205 (S212).

First, feature amounts are extracted from time-series information by the lesson data analysis program 1080204. The extraction results of feature amounts are shown in the middle column of FIG. 5. Concerning the lesson content A, the writing (time) on the electronic blackboard is 80% of the lesson time, voice (time) of the teacher is 90% and voice of students is 5% or less. Meanwhile, student input (time) is 90%, therefore, writing is performed at the timing corresponding to the electronic blackboard. Then, the lesson type is classified as “reproduction of blackboard writing” and the attitude type is classified as “concentration” regarding the lesson content A according to the type classification by the type classification program 1080205 in response to the analysis results. The evaluation of the content A by the content evaluation program 1080206 is the highest (A-level).

Concerning the lesson content B, the writing (time) on the electronic blackboard is 30% or less of the lesson time, voice (time) of the teacher is 50% and voice of students is 30%. Meanwhile, student input (time) is 70%. However, voice information of students responding to voice information of the teacher, namely, voice turns are few and the voice volume is reduced. The lesson type is classified as “teacher/pupil turn” and the attitude type is classified as “attentive hearing” regarding the lesson content B according to the type classification by the type classification program 1080205 in response to the analysis results. The evaluation of the content B by the content evaluation program 1080206 is considerably lower (C-level) because the response of students with respect to the questions by the teacher is not good and part of students does not perform the input by the tablet PC, in other words, part of students does not participate in the lesson.

Concerning the lesson content C, the writing (time) on the electronic blackboard is 5% or less of the lesson time, voice (time) of the teacher is 10% or less and voice of students is 90%. The input (time) by the students is 90%. There is no voice turn and the input by the students is performed only in units of groups. In the last half period of time, part of students does not perform input by the tablet PC. The lesson type is classified as “group discussion”. The attitude type is classified as “divergence” in the front half and classified as “attentive hearing” in the last half regarding the lesson content C according to the type classification by the type classification program 1080205 in response to the analysis results. The evaluation of the content C by the content evaluation program 1080206 is high (B-level) in the front half, however, the evaluation is the lowest (D-level) in the last half because discussion is not active and the tablet PC is not positively used.

Furthermore, concerning the lesson content D, the writing (time) on the electronic blackboard is 5% or less, voice (time) of the teacher is 10% or less and voice of students is approximately 0%. The input (time) by the students is 5% or less. There is no voice turn and the input by the students is performed by all students. The lesson type is classified as “report forming” and the attitude type is classified as “writing quietly” regarding the lesson content D according to the type classification by the type classification program 1080205 in response to the analysis results. As all the students perform the input, the evaluation of the content D by the content evaluation program 1080206 is high (B-level).

Next, the system (server 104) generates classification results/class type information/evaluation/video information as content tag data by the content-tag data generation program 1080207 and stores the information in the database (S213).

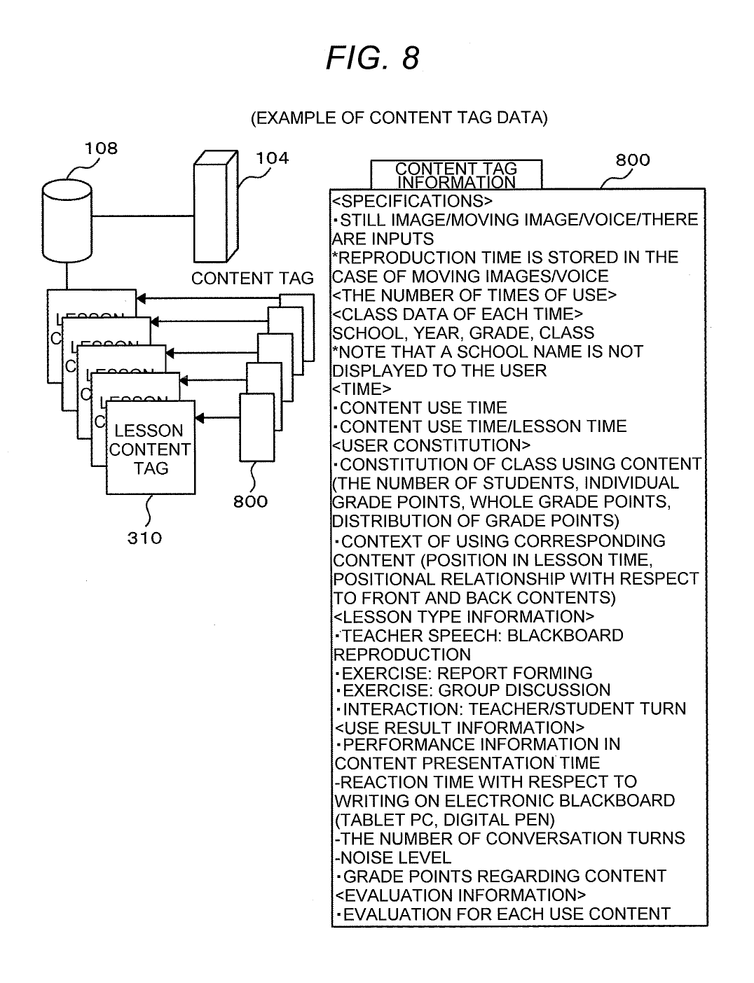

First, a content tag 800 including content tag data (content tag information) as shown in FIG. 8 is added to each lesson content. That is, the content tags 800 generated based on the lesson results are added to respective lesson contents respectively, and structuring of the learning contents is completed. The content tag data includes the following tag information.

### <Specifications>

Sections of still image/moving image/voice/there are inputs and so on

(Reproduction time is stored in the case of moving image/voice)

### <The Number of Times of Use>

The number of times using the content

### <Class Data of Each Time>

School, year, grade, class

(Note that a school name is not displayed to the user)

### <Time>

Content use time or

Content use time/lesson time

### <User Constitution>

Constitution of a class using the content (the number of students, the whole and individual grade points, distribution of grade points=class data)

Context of using the corresponding content (position in the lesson time, positional relationship with respect to previous and next contents)

### <Lesson Type Information>

Teacher speech: blackboard reproduction

Exercise: report forming

Exercise: group discussion

Interaction: teacher/student turn and so on

### <Use Result Information>

Performance information in content presentation time

Reaction time with respect to writing on electronic blackboard (tablet PC, digital pen)

The number of conversation turns

Noise level

Grade points regarding the content

(For example, science→(individual) grade point and so on)<

### <Evaluation Information>

Evaluation for each used content

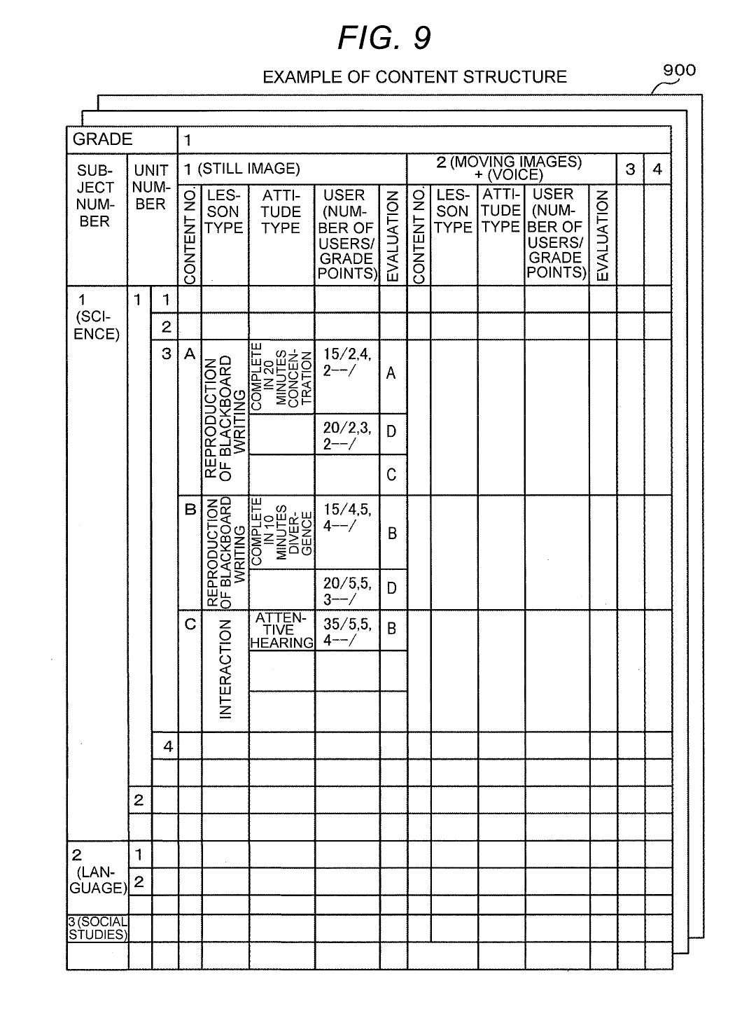

The leaning content, the content tag generated based on the result of the lesson using the content and class type data including information of the grade, the subject and so on are associated, thereby generating a lesson content information table 900 including content evaluation results (history data) as shown in FIG. 9.

In the lesson content information table 900, items such as a unit number, a still image, a moving image and voice are provided in units of grades and subjects. For example, concerning a unit number 1-3 of science in the first grade, the content A uses the still image and the lesson type is “reproduction of blackboard writing”. The first lesson takes 20 minutes, the attitude type is “concentration”, the number of users (pupils) is 15 which is a group having approximately middle grade points as the class type. The evaluation is the highest (A-level). In the second lesson, the number of users (pupils) is 20 which is a group having relatively lower grade points as the class type. The evaluation in this case is the lowest (D-level). Also concerning the same unit number 1-3, the content B also uses the still image and the lesson type is “reproduction of blackboard writing”. Though the first lesson takes 10 minutes, grade points of the users (pupils) in the group are relatively high, the attitude type is “divergence” and the evaluation is high (B-level). In the second lesson using the same content, grade points of the users (pupils) in the group are considerably higher as the class type, and the evaluation is the lowest (D-level).

As described above, it is found that effects on the learning differ according to the class type even when using the same content. Therefore, the teacher can receive support for which content should be applied to an education plan of himself/herself by referring to data close to the constitution of the class type to which the lesson is given from data of the evaluated class types in each unit number based on the lesson content information table 900 to know contents having higher evaluations among them.

The lesson content information table 900 is created and accumulated in units of grades and subjects in formats of the lesson feature amount data 1080302, the lesson type data 1080303, the attitude type data 1080304, the class type data 1080305, the content evaluation data 1080306, the content tag data 1080307 and so on in the database 108. Additionally, information is accumulated over plural years during a period in which the same lesson content may be used. Furthermore, information relating to the use of the same lesson content is accumulated for lessons in schools in the same city or town.

In the accumulated information, information contents having low evaluations in every class type as the past performance are sequentially deleted from the list of the lesson content information tables 900, and only contents having higher evaluations in any class type remain in the list. As a result, the contents having low evaluations in every class type are excluded from the target of selection support for the user (teacher), which reduces burden of the teacher.

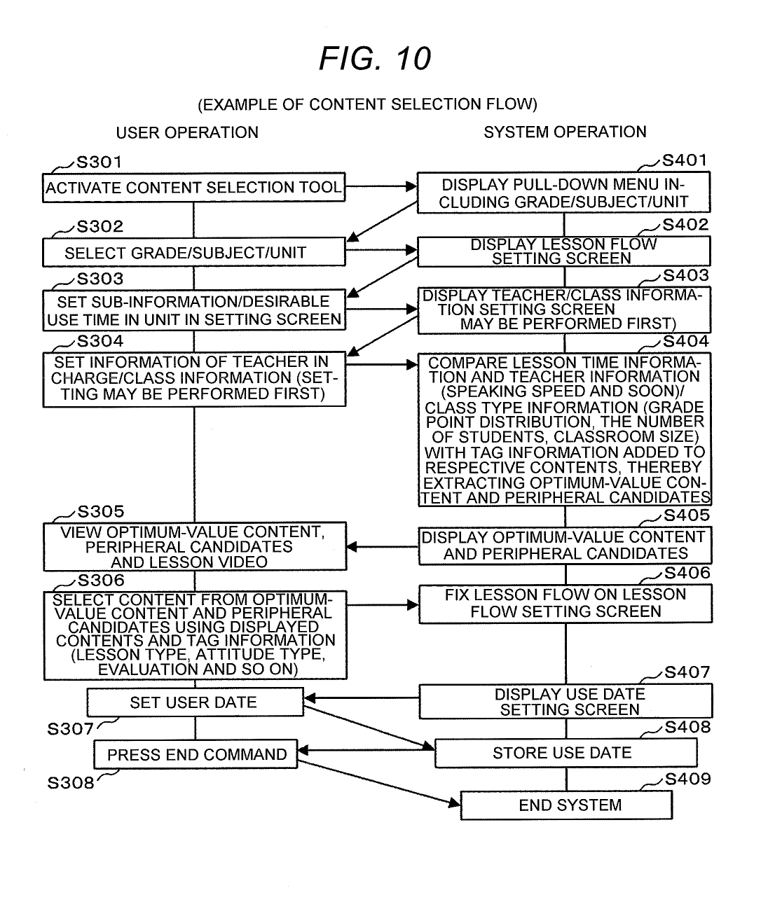

Next, an example of the flow of selecting the evaluated lesson contents by the content selection support program 1080208 will be explained with reference to FIG. 10.

First, the user (teacher) activates a content selection tool on a screen of the client PC 105 through the teacher tablet PC 106 (S301). In response to this, the system (server 104) displays a pull-down menu including grade/subject/unit on the screen of the client PC 105 or the teacher tablet PC 106 (terminal) (S401). When the user (teacher) selects grade/subject/unit (S302), a lesson flow setting screen is displayed on the screen of the terminal (S402). When the user (teacher) sets sub-information/desirable use time in the unit are set on the setting screen (S303), a teacher/class type information setting screen is subsequently displayed on the screen of the terminal (S403), then, the user (teacher) sets information of a teacher in charge/class type information (S304). This setting may be performed first.

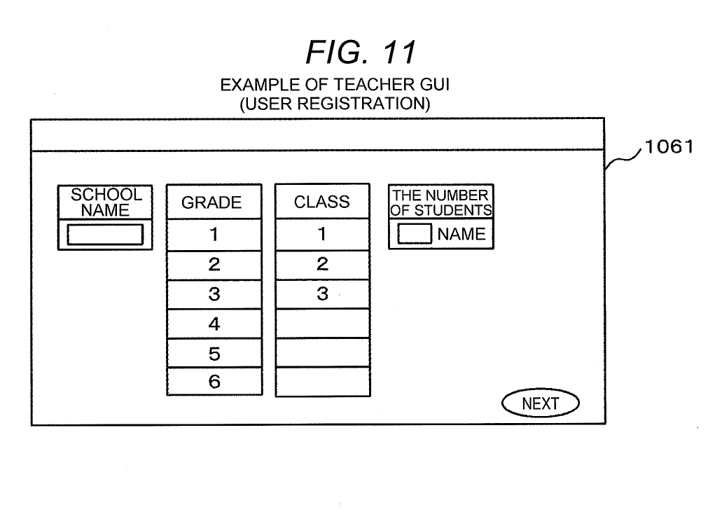

FIG. 11 shows an example of a user registration screen 1061 used when performing user registration by a teacher GUI. The teacher performs registration of users (students) to have the lesson. As input items, there are a school name, a grade, a class and the number of students. The reason why the school name is inputted is that target users of the evaluated lesson contents are assumed to be teachers of plural schools, for example, in the same city or town. When the user selects a “next” button, the screen is changed to a next screen.

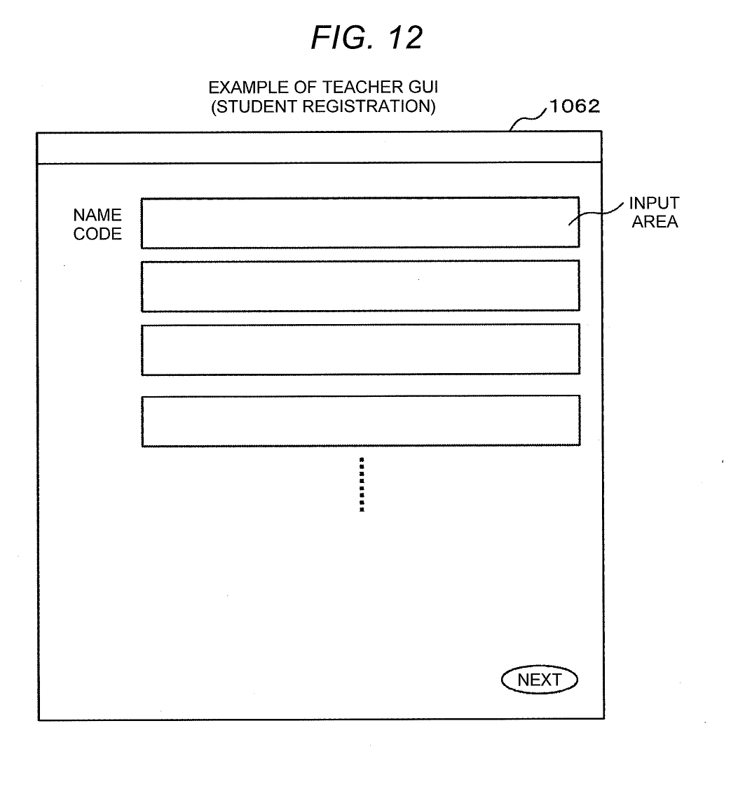

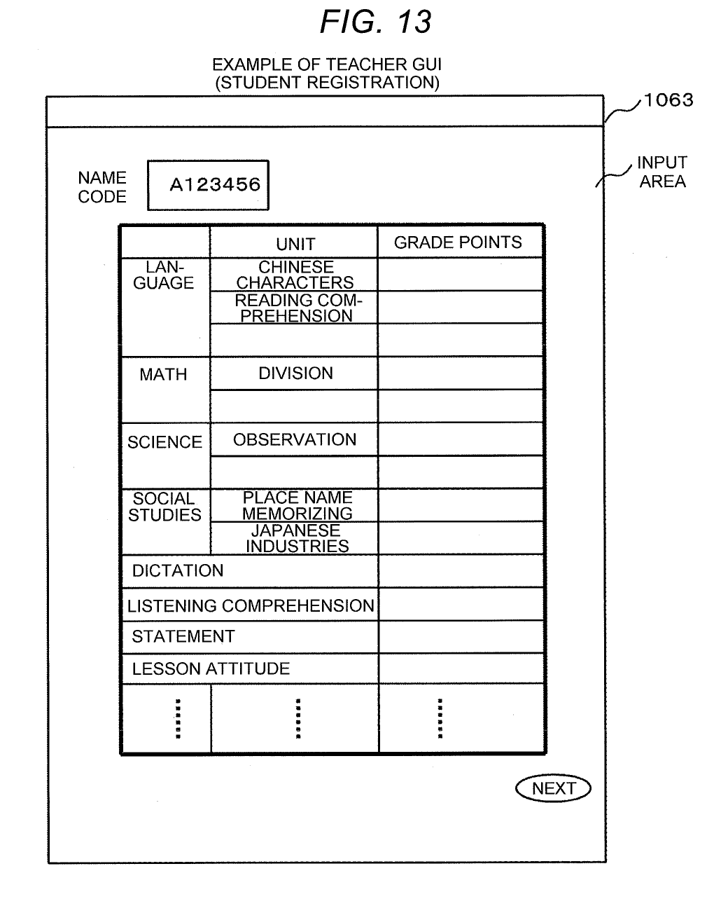

The teacher subsequently perform registration of students by a student registration screen 1062 shown in FIG. 12. That is, the teacher performs registration of identification numbers or name codes of all users (students). The teacher also performs registration of grade points, attitude during lessons and so on of each student according to subjects by a student registration screen 1063 shown in FIG. 13. Accordingly, the input of class type is completed.

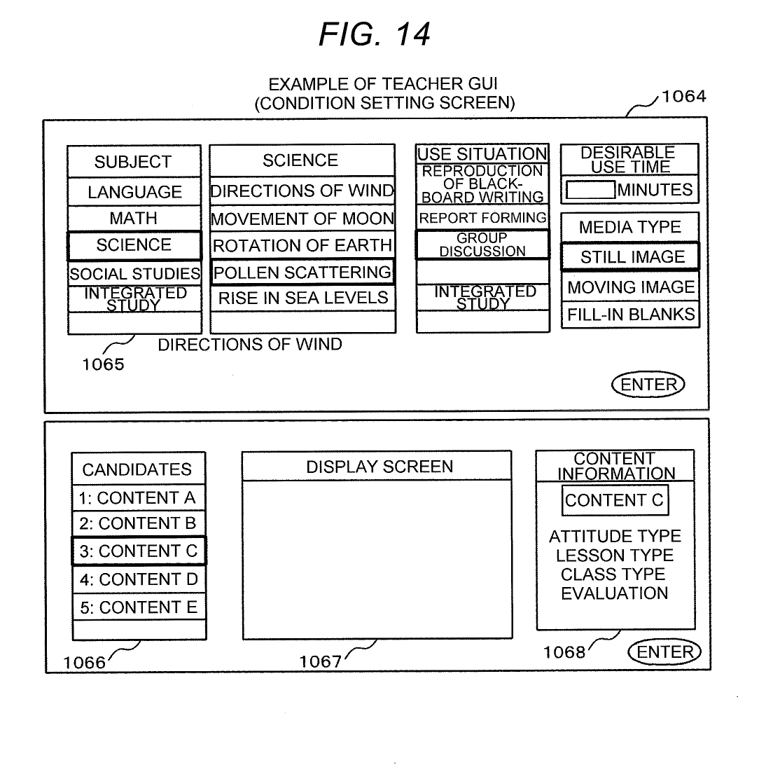

Furthermore, the teacher sets conditions regarding use of the lesson content by a condition setting screen 1064 shown in FIG. 14. For example, when science is selected as the subject, “pollen scattering” in science is subsequently selected, then, “group discussion” is set as a use situation of the content and “still image” is set as a media type. In response to this, the system (server 104) compares lesson time information and teacher information (speaking speed and so on)/class type information (grade point distribution, the number of students, classroom size) with tag information added to respective contents by referring to the lesson content information table 900 and so on, thereby extracting an optimum-value content and peripheral candidates (S404). Then, the server 104 displays the optimum-value content and peripheral candidates on the condition setting screen of the terminal (S405).

FIG. 14 shows an example of the condition setting screen 1064 set by the teacher GUI. When the teacher selects and operates a column of a subject setting menu 1065 on the screen 1064 of the terminal to perform setting of conditions which are, for example, “science”=>“pollen scattering”=>“group discussion”=>“still image” and so on, the optimum-value content and peripheral candidates corresponding to the set conditions on a “candidate list” 1066 (S305). In the case where the teacher selects one content, a “lesson video” 1067 regarding the selected content is displayed, and the teacher can also see the evaluated tag information as shown in FIG. 9 as a “content information” 1068 regarding the selected content. The teacher can easily determine whether the content is suitable for the lesson during planning or not by estimating advantages and disadvantages of the selected content based in the information.

The teacher selects, for example, “content C” from the optimum-value content and peripheral candidates by using the displayed contents and tag information (lesson type, attitude type, evaluation and so on) (S306). In response to this, the system (server 104) displays the lesson flow setting screen on the screen of the terminal to fix the lesson flow (S406). Subsequently, the system (server 104) displays a use date setting screen on the screen of the terminal (S407). The teacher sets a date of using the content (S307).

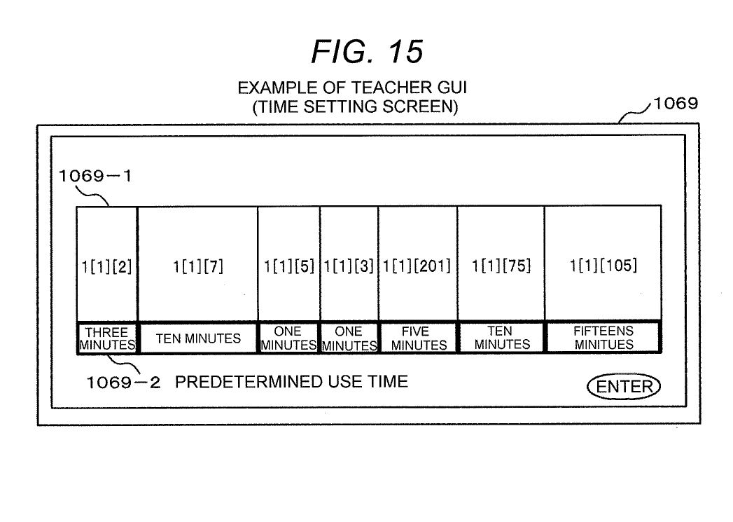

FIG. 15 shows an example of a time setting screen 1069 of the content in the teacher GUI. In the time setting screen 1069, the selected series of lesson contents 1069-1 and a predetermined use time 1069-2 of respective lesson contents are displayed as one set.

The system (server 104) stores the selected lesson content which is, for example, “content C” and the set use date in the memory or the database as the content use time table 1080308 (S407). Then, when the teacher presses an end command (S308), the system ends the operation (S408). The teacher gives the lesson of himself/herself by using the lesson content prepared in the above manner. A new evaluation result of the content based on a result of the lesson is added to the content tag data 1080307.

According to the embodiment, the device of structuring learning contents for supporting selection of the learning contents based on data of actual using states of the learning contents can be provided. Additionally, the system and the method of supporting the learning contents whereby high learning effects can be expected by applying the structuring device.

### Embodiment 2

The present invention can be also applied to not only the lesson given by the teacher at school but also a case where a lecturer gives a lecture at a company and other occasions. The occasions include a case where information relating to the class type, namely, information relating to the size of a lecture room in which the lecture is given, the number of students (pupils), ability distribution and so on has been obtained in advance and the lecturer makes a plan of his/her lecture and executes the plan by choosing a suitable lesson content from plural lesson contents provided in accordance with a series of curriculum, for example, in an English school, educations relating to IT (information technology) and the like. In this case, space corresponding to the classroom such as the lecture room, a large-sized display screen with a GUI function corresponding to the electronic blackboard installed in the space, a lecturer terminal, a student terminal, a client PC and a lesson video imaging camera/microphone imaging states of the lecturer and students during the lecture are necessary in the same manner as the example shown in FIG. 1. In an environment where specifications of the camera are limited, information during the lecture can be picked up only by the microphone. In the case where the series of curriculum is constructed for the education of working people or companies, the present invention can be applied by applying experience years, the degree of comprehension and so on of students as information relating to the class type instead of objective determination of ability such as a test. As the evaluated content information table is created and accumulated according to the class type or the subject of the lecture, the lecturer can perform selection of the evaluated contents by the content selection program.

Also according to the embodiment, it is possible to provide a device of structuring learning contents suitable for the lesson plan of the teacher himself/herself as well as whereby high learning effects can be expected. It is also possible to provide a system and a method supporting the selection of learning contents whereby high learning effects can be expected by using the structuring device.

### Embodiment 3

In Embodiments 1 and 2, the content information table is generated while using contents as well as new data is also accumulated so that the result reflects on the selection of contents for the next lesson or lecture.

However, content information in which data is accumulated by giving lessons or lectures for the certain number of times may be used repeatedly in later lessons and lectures as it is depending on the type of contents. In the present embodiment, information regarding learning contents generated and structured in Embodiments 1 and 2 is used. The database 108 includes the control unit 10801, the memory 10802 and the hard disk 10803. In the hard disk 10803, the lesson data 1080301 accumulated by the lesson data acquisition program 1080203 and so on are stored.

In the present embodiment, as the programs of FIG. 2 are executed on the CPU 1041 by using respective devices of the delivery system of FIG. 1, the programs allows the CPU to execute the following functions. The content selection support program 1080208 allows the CPU to function as a content selection support unit generating candidate contents to be presented to the user based on the content tag data 1080307 when the user selects the contents. The lesson menu setting program 1080209 allows the CPU as a lesson menu setting unit presenting the menu screen necessary for setting the lesson menu by the user through the GUI, accumulating the set lesson menu in the hard disk 10803 as the content use time table 1080308.

The teacher selects the evaluated lesson content and sets the use date of the content by receiving support by the content selection support program 1080208. In the embodiment, the lesson video imaging camera/microphone and so on for acquiring/accumulating new data is not necessary.

Also in the present embodiment, it is possible to provide a device of structuring learning contents suitable for the lesson plan of the teacher himself/herself as well as whereby high learning effects can be expected. It is also possible to provide a system and a method supporting the selection of learning contents whereby high learning effects can be expected by using the structuring device.

What is claimed is:

1. A device of structuring learning contents comprising:
an electronic blackboard displaying a learning content;
a lesson state data acquisition unit acquiring data of a state of a lesson given by displaying the learning content using the electronic blackboard; and
a server connected to the electronic blackboard, the lesson state data acquisition unit and a database through a network,
wherein the server includes
a lesson state data analysis unit extracting a feature amount of the lesson from the lesson state data,
a type classification unit analyzing the feature amount of the lesson and classifying the lesson as a lesson type and an attitude type,
a content evaluation unit evaluating the learning content from the feature amount of the lesson, and
a content-tag data generation unit giving a content tag including content tag data based on the analysis/evaluation result to the learning content to structure the learning contents.

2. The device of structuring learning contents according to claim 1,
wherein the lesson type is a form in which a lesson is given by a teacher,
the attitude type is a pattern indicating response/attitude of pupils during the lesson,
determination conditions necessary for evaluating the learning content based on a relationship of the lesson type and the attitude type are previously set, and
the learning content is evaluated based on the relationship of the lesson type and the attitude type obtained from the feature amount of the lesson.

3. The device of structuring learning contents according to claim 2, further comprising:
a teacher terminal connected to the server through the network,
wherein the teacher terminal has a function of giving class type data including the number of pupils and grade points of a class to be a target of the lesson to the server as data regarding the lesson, and
the content-tag data generation unit generates content tag data structured by combining the result of type classification/evaluation regarding the content with the class type data as a set.

4. The device of structuring learning contents according to claim 3, further comprising:
a camera and a microphone connected to the network,
wherein the lesson state data acquisition unit accumulates information from the electronic blackboard and the camera/microphone in the database as the lesson data, and
the lesson data analysis unit analyzes the lesson data to extract a feature amount, accumulating the result in the database as lesson feature amount data.

5. The device of structuring learning contents according to claim 4,
wherein parameters necessary for performing determination processing of the lesson type and the attitude type are previously set,
the type classification unit analyzes the lesson feature amount and classifies the lesson type and the attitude type based on the parameters, accumulating the results in the database as the lesson type data and the attitude type data.

6. The device of structuring learning contents according to claim 5,
wherein the content evaluation unit evaluates the learning content based on the determination conditions and accumulating the result in the database as the content evaluation result.

7. The device of structuring learning contents according to claim 6, further comprising:
a pupil terminal connected to the server through the network,
wherein the content tag data includes grade point information relating to reaction time of the pupil terminal, the number of conversation turns and a noise level in a period of time during which the learning content is presented on the electronic blackboard as use result information.

8. The device of structuring learning contents according to claim 6, further comprising:
a lesson menu setting unit presenting a menu screen necessary when the user of the teacher terminal sets the lesson menu by a GUI and accumulating the set lesson menu in the database as a content use time table; and
a content selection support unit generating information of at least one learning content to be a candidate with respect to the lesson menu based on the content tag data and presenting the information on the menu screen at the time of setting the lesson menu by the GUI.

9. A learning-content selection support system comprising:
a server connected to a database and a teacher terminal through a network,
wherein the database includes
information of a learning content structure to which content tags including content tag data based on analysis/evaluation results of learning contents are added to be structured, and
a lesson menu setting unit presenting a menu screen necessary when a lesson menu is set by a GUI of the teacher terminal and accumulating the set lesson menu in the database as a content use time table; and
a content selection support unit generating information of plural evaluated learning contents to be candidates with respect to the lesson menu based on the content tag data and presenting the information on the menu screen at the time of setting the lesson menu by the GUI.

10. The learning-content selection support system according to claim 9,
wherein the content tag data includes information relating to a lesson type, an attitude type and evaluation of the learning content,
the lesson type is a form in which a lesson is given by a teacher,
the attitude type is a pattern indicating response/attitude of pupils during the lesson,
the learning content is evaluated based on a relationship of the lesson type and the attitude type obtained from a feature amount of the lesson, and
when any of the plural evaluated learning contents to be candidates is selected by the GUI, information relating to the lesson type, the attitude type and the evaluation of the selected evaluated learning content is presented on the menu screen.

11. The learning-content selection support system according to claim 10,
wherein the content tag data includes information relating to the number of pupils, the whole and individual grade points and grade point distribution of a class using the learning content as class data, and
the content selection support unit generates information of the evaluated learning contents corresponding to the class data given when a lesson menu is set by the GUI of the teacher terminal and presents the information on the menu screen.

12. The learning-content selection support system according to claim 11, further comprising:
an electronic blackboard connected to the server through the network,
wherein lesson data is stored in the database, and
the selected evaluated learning contents are displayed on the electronic blackboard based on information of the content use time table.

13. A learning-content selection support method using a learning-content selection support system which includes a server connected to a database and a teacher terminal through a network, in which the database has information of a learning content structure to which content tags including content tag data based on analysis/evaluation results of learning contents are added to be structured, the support method comprising:
presenting a menu screen necessary when a lesson menu is set by a GUI of the teacher terminal;
accumulating the set lesson menu in the database as a content use time table; and
generating information of plural evaluated learning contents to be candidates with respect to the lesson menu based on the content tag data and presenting the information on the menu screen at the time of setting the lesson menu by the GUI.

14. The learning-content selection support method according to claim 13,
wherein the content tag data includes information relating to a lesson type, an attitude type and evaluation of the learning content,
the lesson type is a form in which a lesson is given by a teacher,
the attitude type is a pattern indicating response/attitude of pupils during the lesson,
the learning content is evaluated based on a relationship of the lesson type and the attitude type obtained from a feature amount of the lesson, and
when any of the plural evaluated learning contents to be candidates is selected by the GUI, information relating to the lesson type, the attitude type and the evaluation of the selected evaluated learning content is presented on the menu screen.

15. The learning-content selection support method according to claim 14,
wherein the content tag data includes information relating to the number of pupils, the whole and individual grade points and grade point distribution of a class using the learning content as class data, and
information of the evaluated learning contents corresponding to the class data given when a lesson menu is set by the GUI of the teacher terminal is generated and the information is presented on the menu screen.
